(19) United States
(12) Patent Application Publication
(10) Pub. No.: US 2026/0183610 A1
(43) Pub. Date: Jul. 2, 2026

(54) METAVERSE SPORTS PLATFORM PROVIDING APPARATUS

(71) Applicant: LG ELECTRONICS INC., Seoul (KR)

(72) Inventors: Seehyung LEE, Seoul (KR); Heejin MOON, Seoul (KR); Eundong SHIN, Seoul (KR)

(73) Assignee: LG ELECTRONICS INC., Seoul (KR)

(21) Appl. No.: 18/858,580

(22) PCT Filed: Apr. 18, 2023
(86) PCT No.: PCT/KR2023/005233

§ 371 Date: Oct. 21, 2024

(30) Foreign Application Priority Data
Apr. 22, 2022 (KR) 10-2022-0050443
Sep. 13, 2022 (KR) 10-2022-0115141

(51) Int. Cl. A63B 24/00; A63B 60/46; A63B 69/36; A63B 71/06; G06F 3/01; G06T 13/40; G06T 17/00; G06T 19/20; G06V 20/60; G06V 40/10; G06V 40/20

(52) U.S. Cl. CPC A63B 24/0006; A63B 60/46; A63B 69/3608; A63B 71/0622; G06F 3/011; G06T 13/40; G06T 17/00; G06T 19/20; G06V 20/60; G06V 40/10; G06V 40/23; A63B 2024/0015; A63B 2071/0636; A63B 2220/806; A63B 2220/833; A63B 2220/836; A63B 2225/50; G06T 2210/16; G06T 2219/2024

(57) ABSTRACT

The present invention relates to a metaverse sports platform providing apparatus. The metaverse sports platform providing apparatus of the present invention comprises: a communication unit that receives an image captured by a camera; a display that outputs the image captured by the camera; and a control unit that causes the display to output an avatar corresponding to a user included in the image by using the image captured by the camera, and controls the movement of the avatar so as to correspond to the user's swing, wherein the control unit analyzes the user's swing and outputs information requiring corrections by using the avatar, and wherein the control unit may analyze the user's swing and output information requiring correction using the avatar.

### TECHNICAL FIELD

The present disclosure relates to an apparatus for providing a metaverse sports platform.

### BACKGROUND ART

A metaverse is a compound word derived from ‘universe,’ meaning the actual world, and ‘meta,’ meaning ‘beyond or transcending,’ referring to a three-dimensional virtual world. The metaverse features user-generated content (UGC) as a commercial product, created by virtual world users, that circulates using virtual currency as the medium.

The metaverse world has been previously expressed as Virtual Reality, but now the term metaverse is mainly used to describe a more advanced concept.

In recent years, the term metaverse has been widely used to describe a vision of fully immersive 3D virtual spaces that extend beyond real-world tasks. Different characters appearing in the virtual space have human-like social or economic interrelationships with software agents (acting as avatars) and use metaphors from the real world, but they are not physically limited.

This metaverse can be utilized in various fields. For example, the metaverse can be utilized in gaming and social networking services (SNS), as well as in fields like education and medicine.

To this end, it is necessary to develop various metaverse platforms and utilize immersion devices, such as a Head-Mounted Display (HMD) supporting the metaverse. Furthermore, there may be a need for interactive processing technologies, experience analyzing and sharing technologies, high-performance wired and wireless network technologies for transferring a vast amount of data, and similar technologies.

### DISCLOSURE OF INVENTION

### Technical Problem

An object of the present disclosure is to provide an apparatus, optimized for a user, for providing a metaverse sports platform by utilizing a metaverse.

### Solution to Problem

In order to accomplish the above-mentioned object or other objects, pursuant to an aspect of the present disclosure, there is provided an apparatus, according to an embodiment of the present disclosure, for providing a metaverse sports platform, the apparatus including: a communication unit that receives a captured image from a camera; a display that outputs the image captured through the camera; and a control unit that, using the image captured through the camera, controls the display in such a manner as to output an avatar corresponding to a user included in the image and controls the avatar's movement in such a manner as to correspond to the user's swing, wherein the control unit analyzes the user's swing and, using the avatar, outputs information necessary for correction.

In an embodiment, the apparatus may further include a sensor that is attached to the user's body and analyzes the user's movement, wherein the control unit controls the avatar's movement in real-time in such a manner as to correspond to the user's swing, based on the image captured through the camera and information collected through the sensor.

In an embodiment, in the apparatus, when the information necessary for correction is output, the control unit may control the display in such a manner that the avatar does not move in accordance with the user's movement.

In an embodiment, in the apparatus, the control unit may set the avatar's clothing in such a manner as to correspond to the clothing worn by the user, using the image captured through the camera.

In an embodiment, in the apparatus, when a first mode is entered, the control unit may analyze the user's swing whose image is captured, through the image, and, when the occurrence of a preset swing reaches or exceeds a reference number of times, may transmit analysis information on the user's swing to a server through the communication unit, and the control unit may receive information on swing correction from the server and may output the information on swing correction through the avatar's movement.

In an embodiment, in the apparatus, when a second mode is entered, the control unit may output to the display a new avatar that moves in such a manner as to correspond to a professional golfer's swing whose image is captured in advance, and may control the display in such a manner as to output both the swing of the avatar that corresponds to the user and the new avatar's avatar.

In an embodiment, the apparatus may further include a sensor that is formed in such a manner as to be attached to a golf club and senses movement information of the golf club.

In an embodiment, in the apparatus, the control unit may generate a swing plane object that is a plane on which the golf club moves, using the information sensed through the sensor, and may control the display in such a manner as to output the swing plane object.

In an embodiment, in the apparatus, the control unit may control the display so that both a corrective swing plane object, which guides a correct swing plane, and the swing plane object are output in an overlapping manner.

In an embodiment, in the apparatus, the control unit may output prestored clothing information to the display in such a manner that the avatar is dressed in a clothing item selected by the user from the prestored clothing information.

In an embodiment, in the apparatus, the control unit may control the avatar dressed in the selected clothing item in such a manner to move in a way that corresponds to the user's movement.

In an embodiment, in the apparatus, in a screen golf mode, the control unit may control the avatar dressed in the selected clothing information in such a manner as to perform a motion corresponding to the user's swing.

In an embodiment, in the apparatus, the control unit may output a digitally twinned virtual space to the display in such a manner as to correspond to an actual golf course and may control the display in such a manner that a situation on the actual golf course whose image is captured through an image capture device is reflected in the digitally twinned virtual space.

In an embodiment, in the apparatus, the control unit may output onto the virtual space a first avatar corresponding to the user whose image is captured through the camera, and a second avatar corresponding to a player who plays on the actual golf course.

In an embodiment, in the apparatus, the control unit may control the movement of the second avatar corresponding to a player in such a manner that the movement thereof corresponds to the swing of the player whose image is captured through the image capture device within the virtual space.

In an embodiment, in the apparatus, in a case where the swing of the user, who is present in front of the camera, is in progress, the control unit may control the display in such a manner that a point in time in the virtual space is changed or that the second avatar corresponding to the player does not move.

### Advantageous Effects of Invention

According to the present disclosure, posture correction of the user's movement can be provided more intuitively through a user-based avatar based on a metaverse.

In addition, according to the present disclosure, the user-based avatar can be dressed in sports-associated clothing, and various content items can be provided by utilizing this user-based avatar. Consequently, a metaverse sports platform that enables a realistic reflection, as if the user were present in person in the metaverse, can be provided.

In addition, according to the present disclosure, a new sports platform capable of providing more diverse content items can be established by performing relay between a studio and an actual field through the metaverse.

### BRIEF DESCRIPTION OF DRAWINGS

FIG. 1 is a conceptual diagram referenced to describe an apparatus for providing a metaverse sports platform.

FIGS. 2, 3, 4, and 5 are conceptual diagrams referenced to describe various functions capable of being provided by the apparatus, according to the present disclosure, for providing a metaverse sports platform.

FIG. 6 is a flowchart referenced to describe a method, according to an embodiment of the present disclosure, of controlling the apparatus for providing a metaverse sports platform.

### MODE FOR THE INVENTION

It should be noted that the technical terms used in this specification are only used to describe specific embodiments and are not intended to limit the present disclosure. A singular representation used herein may include a plural representation unless it represents a definitely different meaning from the context. A suffix such as “module” and “unit” may be used to refer to elements or components. Use of such a suffix herein is merely intended to facilitate description of the specification, and the suffix itself is not intended to give any special meaning or function.

In this application, the terms “comprising” and “including” should not be construed to necessarily include all of the elements or steps disclosed herein, and should be construed not to include some of the elements or steps thereof, or should be construed to further include additional elements or steps.

In describing the present disclosure, if a detailed explanation for a related known function or construction is considered to unnecessarily divert the gist of the present disclosure, such explanation has been omitted but would be understood by those skilled in the art.

The accompanying drawings are used to help easily understand the technical idea of the present disclosure and it should be understood that the idea of the present disclosure is not limited by the accompanying drawings. The idea of the present disclosure should be construed to extend to any alterations, equivalents and substitutes besides the accompanying drawings. It should also be understood that each of embodiments described below and combinations of those embodiments are all changes, equivalents, or substitutes which can belong to the idea and scope of the present disclosure.

The configuration and operation of the present disclosure will be described in more detail below with reference to the multiple drawings associated with the present disclosure.

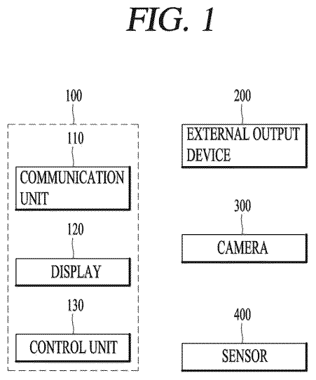

FIG. 1 is a conceptual diagram referenced to describe an apparatus for providing a metaverse sports platform.

Examples of an apparatus 100 according to the present disclosure for providing a metaverse sports platform may include a computer, a terminal, a laptop computer, and a notebook computer. Additionally, they may include a smartphone, a tablet PC, a cellular phone, a personal communication service (PCS) phone, a mobile terminal for synchronous/asynchronous International Mobile Telecommunication-2000 (IMT-2000), a palm personal computer, a personal digital assistant (PDA), and similar devices.

In addition, the apparatus for providing a metaverse sports platform may receive a request from a client and may accordingly communicate with a server that performs information processing.

In addition, an apparatus according to an embodiment of the present disclosure for providing a metaverse sports platform may be a mobile terminal.

Examples of the mobile terminal described in the present specification may include a portable phone, a smartphone, a laptop computer, a terminal for digital broadcast, personal digital assistants (PDA), a portable multimedia player (PMP), a navigation, a slate PC, a tablet PC, an ultrabook, a wearable device (for example, a smartwatch, smartglasses, a head-mounted display (HMD), or similar device.

For convenience of description, the apparatus for providing a metaverse sports platform and a computer (or server) will be interchangeably used hereinafter in the present specification. In addition, a method of controlling the apparatus for providing a metaverse sports platform may be understood as being performed by the image processing apparatus or a computer (server) as the primary entity.

With reference to FIG. 1, the apparatus 100 according to the present disclosure for providing a metaverse sports platform may include a communication unit 110, a display 120, and a control unit 130.

The communication unit 110 may be formed in such a manner as to communicate with various communication-capable apparatuses.

The communication unit 110 is a device for performing communication with an external device. The external device here may be another vehicle, a mobile terminal, or a server.

In order to perform communication, the communication unit 110 may include at least one of the following: a transmission antenna, a reception antenna, or a radio frequency (RF) circuit or element capable of executing various communication protocols.

The communication unit 110 may include a short-range communication unit, a location information unit, an optical communication unit 440, a broadcast transceiver, and a processor.

According to an embodiment, the communication unit 110 may include one or more constituent elements other than constituent elements described below and may omit one or more of the constituent elements described below.

The short-range communication unit is a unit for short-range communication. The short-range communication unit may support short-range communication, using at least one of the following technologies: Bluetooth™, Infrared Data Association (IrDA), Ultra-Wideband (UWB), ZigBee, Near Field Communication (NEC), Wireless-Fidelity (Wi-Fi), Wi-Fi Direct, and Wireless Universal Serial Bus (USB).

The short-range communication unit may form short-range wireless area networks and thus may perform short-range communication between the apparatus 100 for providing a metaverse sports platform and at least one external device.

The location information unit is a unit for acquiring location information of the apparatus 100 for providing a metaverse sports platform. For example, the location information unit may include a Global Positioning System (GPS) module or a Differential Global Positioning System (DGPS) module.

The optical communication unit is a unit for performing communication with an external device using light as a medium. The optical communication unit may include an optical transmission unit that converts an electrical signal into an optical signal and transmits the optical signal, and an optical reception unit that converts the received optical signal into an electrical signal.

The broadcast transceiver is a unit for receiving a broadcast signal from an external broadcast management server through a broadcast channel and transmitting a broadcast signal to the broadcast management server through the broadcast channel. The broadcast channels may include a satellite channel and a terrestrial channel. The broadcast signals may include a TV broadcast signal, a radio broadcast signal, and a data broadcast signal.

The processor may control overall operations of each unit of the communication unit 110.

According to an embodiment, the communication unit 110 may include a plurality of processors or may not include a processor.

In a case where a processor is not included in the communication unit 110, the communication unit 110 may operate under the control of the control unit 130 within the apparatus 100 for providing a metaverse sports platform.

The communication unit 110 may be referred as to a telematics device.

The display 120 may include at least one of the following: a liquid crystal display (LCD), a thin film transistor-liquid crystal display (TFT LCD), an organic light-emitting diode (OLED), a flexible display, a 3D display, or an e-ink display.

The display 120 may have an inter-layered structure or an integrated structure with a touch sensor in order to realize a touch screen.

In addition, the display 120 may include various types of display units, such as a beam projector, a signage, a hologram, an AR/VR output device, and a transparent display.

The transparent display has a predetermined level of transparency and may display a predetermined screen. In order to have transparency, the transparent display may include at least one of the following: a transparent Thin Film Elecroluminescent (TFEL), a transparent Organic Light-Emitting Diode (OLED), a transparent Liquid Crystal Display (LCD), a transmission-type transparent display, or a transparent Light Emitting Diode (LED) display. The transparency of the transparent display may be adjusted.

The apparatus 100 according to the present disclosure for providing a metaverse sports platform may further include a camera 300 formed in such a manner as to capture an image of a user, an external output device 200 capable of outputting to the outside other than the display and a sensor 400 formed in such a manner as to sense the user's movement.

The external output device 200 may be the display 120 described above. The description of the display 120 may apply to the external output device 200 in the same or similar manner.

The apparatus 100 for providing a metaverse sports platform may be installed in, for example, a studio where the user can perform various indoor exercises, such as golf, baseball, and Pilates.

The apparatus 100 according to the present disclosure for providing a metaverse sports platform may provide various metaverse-applied content items (a lesson, screen golf, screen baseball, educational content, correction content, real-time interactive content, a remote battle, a remote lesson, and the like) to the user who performs an exercise in the studio.

Various specific functions of the apparatus for providing a metaverse sports platform will be described in more detail below with reference to the accompanying drawings.

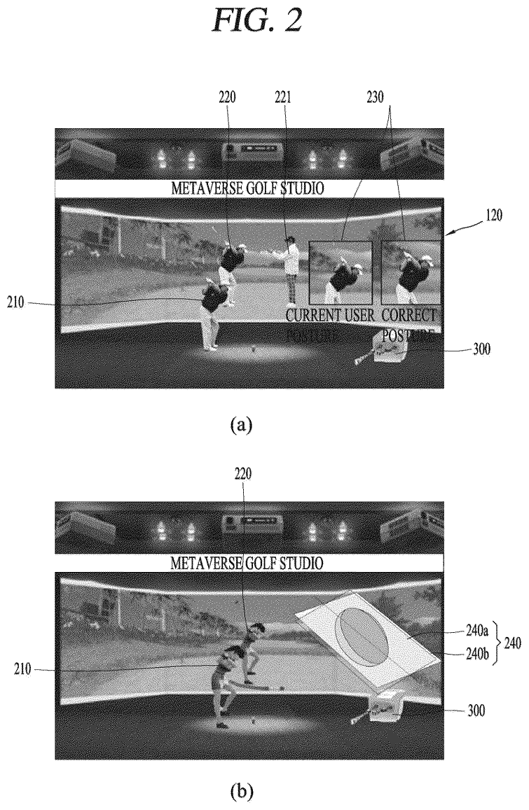

FIGS. 2, 3, 4, and 5 are conceptual diagrams referenced to describe various functions that are capable of being provided by the apparatus according to the present disclosure for providing a metaverse sports platform.

The communication unit 110 according to the present disclosure will receive an image captured from the camera 300.

The display 120 may output the image captured through the camera 300.

With reference to FIG. 2, using the image captured through the camera, the control unit 130 may control the display in such a manner as to output an avatar corresponding to a user included in the image and may control the avatar's movement in such a manner as to correspond with the user's swinging.

In addition, the control unit 130 may analyze the user's swinging, and, using the avatar, may output information necessary for correction.

In the present specification, for convenience of description, the user's movement will be described taking a golf swing as an example. Additionally, golf will be used as an example of a sport. However, the user's movement is not limited thereto. The description of the user's movement in the present specification may inferentially apply to all types of sports involving the user's movement or posture in the same or similar manner.

As an example, although not illustrated, the apparatus 100 according to the present disclosure for providing a metaverse sports platform may further include a sensor that is worn on the user's body and analyzes (senses) the user's movement. This sensor may be formed as a plurality of gyro sensors.

The control unit 130 may control the avatar's movement in real-time in such a manner as to correspond to the user's swing, based on an image captured through the camera and information collected through the sensor.

With reference to (a) of FIG. 2, the apparatus 100 according to the present disclosure for providing a metaverse sports platform may analyze the user's swing (or the user's movement) and may generate an avatar 220 accordingly, based on the image captured through the camera and a sensor worn on a user 210.

Subsequently, the control unit 130 may output the generated avatar 220 to the display 120 so that the avatar 220 moves in a manner corresponding to the user's swing (or to move in the same motion as the user's swing).

In addition, the control unit 130 may analyze the user's swing and, using the avatar 220, may output information 230 necessary for correction. At this point, the control unit 130, as illustrated in (a) of FIG. 2, may also output the information 230 necessary for correction as additional information generated from duplicating the avatar. Additionally, the control unit 130 may display a portion of the generated avatar 220 that needs correction or output information necessary to correct the avatar's movement (that is, swing correction information).

At this point, the control unit 130, as illustrated in (b) of FIG. 2, may set (or determine) the avatar 220's clothing in such a manner as to correspond to the clothing worn by the user, using the image captured through the camera.

That is, the avatar may be set to wear clothing in such a manner as to correspond to the clothing actually worn by the user and may be output accordingly to the display unit 120. Consequently, a metaverse where the actual user appears to be present in a virtual world can be realized.

The apparatus 100 according to the present disclosure for providing a metaverse sports platform may provide an Artificial Intelligence (AI) avatar teaching function in a metaverse golf studio.

To this end, the apparatus 100 for providing a metaverse sports platform may provide a golf lesson through a coaching-capable AI avatar that achieves the best shot tailored to the user's body type and swing balance through accumulated data and learning.

As an example, the control unit 130 may provide various teaching programs, such as a program for following along with a famous professional golfer's swing and a program for swing teaching tailored to my needs.

The control unit 130 may compare a trajectory of the user's swing with that of a famous professional golfer's swing and may quantify the extent of the similarity to a guideline until the user's swing achieves a similar trajectory, thereby enabling the user to engage in repetitive learning.

In addition, the control unit 130 may provide a guideline by having an AI coach avatar analyze a user avatar's swing within a metaverse space and may propose a ‘perfect shot’ swing tailored to the user's body type, which the user can then learn.

The apparatus 100 according to the present disclosure for providing a metaverse sports platform is capable of operating in conjunction with the user's swing in real-time within a metaverse. To this end, the control unit 130 may capture an image of the user's swing using the camera and the sensor and may output the simultaneous swing of a preset user's avatar to a metaverse screen.

In addition, the control unit 130 may perform basic swing data analysis. Specifically, the control unit 130 may provide sense/analyze information (including a ball speed, a launch angle, left and right starting angles, a total amount of rotation, a rotational axis, a club speed, an impact point, an attack angle, a club pass, a face angle, an impact loft, an amount of head rotation, a lie angle, and similar data) associated with a ball/club using the camera or the sensor and may provide the resulting analysis data.

In addition, the control unit 130 may analyze the user's swing form (a swing posture, a swing trajectory, and a swing motion) using a human-joint tracking technology that uses a camera and a sensor.

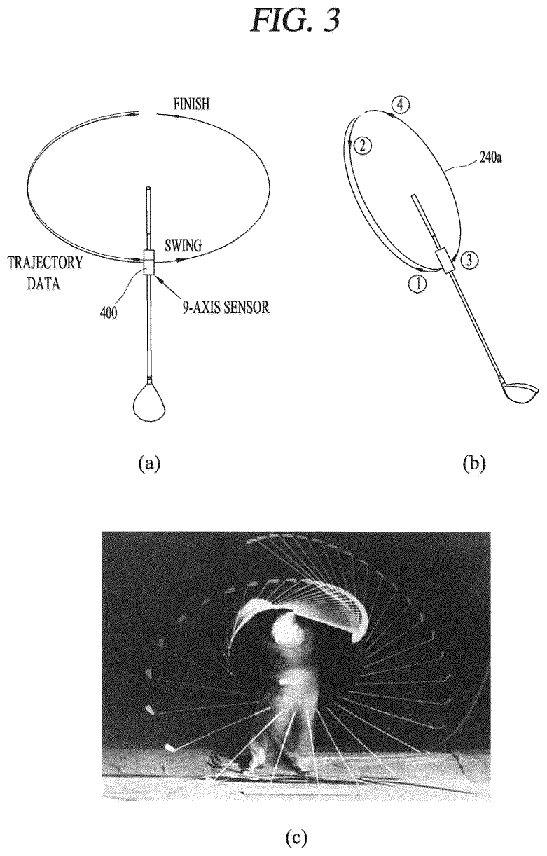

With reference to (a) of FIG. 3, according to the present disclosure, the sensor 400 that is formed in such a manner as to be attached to a golf club 410 and senses movement information of the golf club 410 may be further included.

The sensor 400 may be a 9-axis sensor formed in such a manner as to measure swing trajectory data.

The sensor 400 may be attached to the golf club 410 and may measure the movement of the sensor while the golf club is swung by the user. Then, the sensor 400 may transmit the measured data to the control unit 130 through the communication unit 110.

As illustrated in (b) of FIG. 3, the control unit 130 may determine a swing plane, which is a plane on which the golf club moves, using the information sensed through the sensor 400, and may generate a swing plane object.

The control unit 130 may control the display 120 in such a manner as to output a swing plane object 240a.

The control unit 130 may load (or generate) a corrective swing plane object that guides the user to achieve a correct swing plane, based on swing plane information optimized for each human body, which is stored in memory (not illustrated).

The control unit 130, as illustrated in (b) of FIG. 2, may control the display 120 so that both a corrective swing plane object 240b, which guides a correct swing plane, and a swing plane object 240a for the user, which is sensed through the sensor, are output in an overlapping manner.

That is, the control unit 130 may output a swing trajectory and a swing plane in an overlapping manner to a swing screen for a player.

To this end, as an example, the camera may be arranged to capture images in both the front and rear surface directions with the user in the middle. Swing data may be generated (determined) by computing a trajectory based on the user's swing motion recognized by the camera and on the initial position of the sensor attached to the golf club.

As an example, according to the present disclosure, a microcomputer is added to the sensor 400 attached to the golf club. The trajectory data (that is, the swing plane information) in space is analyzed while the golf club is swung by the user, and an analysis result is output to the display, thereby enabling the user to see the swing trajectory.

The control unit 130 according to the present disclosure, as illustrated in (c) of FIG. 3, may also capture an image of the user's swing at predetermined time intervals using a high-speed camera or the sensor 400 and output the captured images in an overlapping manner.

That is, according to the present disclosure, the swing data may be collected through an attached-type sensor, and swing data analysis may be performed on the collected swing data of the user.

To this end, according to the present disclosure, the 9-axis sensor may be attached to the shaft of the golf club, and pattern data on the trajectory of the user's swing may be collected. Additionally, the 9-axis sensor may be attached in an attachable manner to the user's individual club and used.

In addition, the control unit 130 may analyze a swing pattern on the basis of the collected swing data of the user and may compare the trajectory of the user's swing (a swing plane generated by the sensor) with an optimized trajectory of swing (a corrective plane that guides the user to achieve the correct swing plane), thereby providing a swing guide 240.

When the user attaches the 9-axis sensor to the golf club and swings the golf club, the control unit 130 may measure the spatial coordinates of the golf club. Then, the control unit 130 may determine the extent of the similarity of a trajectory of the player's swing to a corrective swing plane, thereby providing an interface through which the player's swing can be analyzed.

In addition, the control unit 130 may express (replay) the player's swing posture using an avatar in an indoor screen golf, and may display a swing plane in a way that overlaps with the avatar. In this manner, the control unit 130 may provide a golf game in which the player appears to actually swing the golf club. Furthermore, through the avatar, the control unit 130 may also remotely provide the player's swing posture to another user who is located at a remote distance.

A sportswear fitting service that uses the metaverse according to the present disclosure may be provided.

Specifically, the control unit 130 may scan the user's body through the camera 300, generate the user's avatar, and select a sportswear to be worn within the metaverse space.

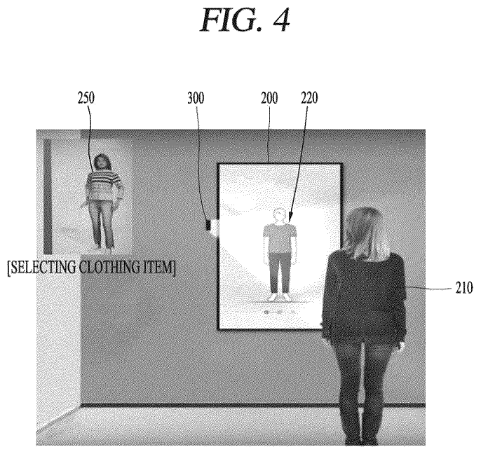

The control unit 130, as illustrated in FIG. 4, may generate the avatar 220 using information on the user's body, which is sensed through the camera 300 and may output the generated avatar 220 to the display or the external output device 200.

The control unit 130 may output prestored clothing information to the display (or the external output device 200) in such a manner that the avatar 220 is dressed in a clothing item 250 selected by the user from the prestored clothing information.

The control unit 130 may control the avatar so that the avatar, wearing the selected clothing item, moves in a way that corresponds to the user's movement.

In addition, in a screen control mode, the control unit 130 may also control the avatar dressed in the selected clothing item in such a manner as to perform a motion corresponding to the user's swing.

The apparatus 100 according to the present disclosure for providing a metaverse sports platform may provide golfwear fitting and offline shopping services.

To this end, the control unit 130 may output various clothing items, shoes, hats, accessories, and the like that are provided by golfwear brands, and the user may make a selection from these.

The control unit 130 may control the avatar in such a manner as to wear the selected clothing and move within the metaverse space.

In addition, according to the present disclosure, an accompanying service may be provided that allows the user to actually purchase clothing on the basis of the avatar generated by analyzing the size of his/her body. Accordingly, the user may purchase clothing tailored to the size of his/her body without the need to visit a store and try it on.

In addition, the apparatus 100 for providing a metaverse sports platform may provide a content market, such as a market for golfwear, and a creator support service.

To this end, the control unit 130 may establish a market in such a manner that revenue can be generated by designing and selling content, such as golfwear, accessories, and goods, and may provide a platform capable of supporting creative activities.

Moreover, as an example, when the screen golf mode is executed (a game is played), the control unit 130 may generate an avatar that resembles the body type corresponding to each user and may enable the player to select his/her desired clothing item from golf clothing and dress the avatar in the desired clothing item based on 3D clothing data. Then, when the user swings the golf club, the control unit 130 may move the avatar so that the avatar, dressed in the desired clothing item, corresponds to the user's swing. In this manner, the control unit 130 may provide a platform for remotely playing a round with another user within the metaverse.

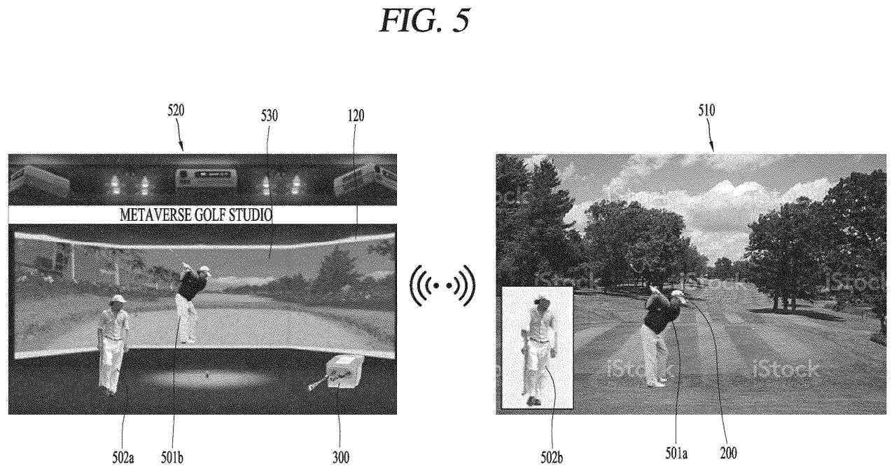

With reference to FIG. 5, according to the present disclosure, an on/offline remote live round service can be provided.

For example, the apparatus for providing a metaverse sports platform may provide a service for remotely playing a round with an acquaintance, who is playing on a digitally twinned real-world golf course, within a studio 520.

For example, the control unit 130, as illustrated in FIG. 5, may output a digitally twinned virtual space 530 to the display 120 in such a manner as to correspond to an actual golf course 510.

Subsequently, the control unit 130 may control the display 120 in such a manner that a situation on an actual golf course whose image is captured through an image capture device (for example, a camera provided on a golf cart or a separate camera with which the user captures an image) is reflected in the digitally twinned virtual space.

The control unit 130 may output a first avatar (not illustrated) and a second avatar onto the virtual space 530. The first avatar corresponds to a user 502 whose image is captured through a camera (a camera provided in the studio), and the second avatar corresponds to a player 501a who is playing on the actual golf course.

The control unit 130 may control the movement of the second avatar 501b corresponding to the player 501a in such a manner that the movement thereof corresponds to the swing of a player whose image is captured through the image capture device (an image capture device capturing an image on an actual golf course) within the virtual space 530.

In a case where the swing of the user 502, who is present in front of the camera 300 provided in the studio 520, is in progress, the control unit 130 may control the display 120 in such a manner that a point in time in the virtual space 530 is changed or that the second avatar 501b corresponding to the player does not move, allowing the player within the studio to experience the feeling of playing a round on an actual golf course.

As illustrated in the right-side image of FIG. 5, the control unit 130 may output an avatar (such as a hologram or an AR object) 502b corresponding to the user 502, who is swinging the golf club in the studio, through the external output device 200 (for example, AR glasses) worn by the player 501a present in an actual field.

The avatar 502b may move in such a manner as to correspond to the swing of the user 502 whose image is captured through the camera 300 in the studio 520.

A point at which the avatar 502b moves may be a location on an actual golf course that corresponds to a point in a virtual space that is being output to the display at a point in time when the user swings the golf club in the studio.

That is, in a case where a player on an actual golf course reaches an actual space corresponding to a point in the virtual space, the control unit 130 may output the avatar 502b through the external output device 200 for the player 501a in such a manner that the movement thereof corresponds to the swing of the user 502 whose image is captured in the studio.

As an example, the control unit 130 may capture an image of the scene through the camera within the golf cart and may transmit data. Additionally, the control unit 130 may transmit information on a digitally twinned golf course to the studio.

The control unit 130 may capture an image of the scene of a player playing on a golf course through the camera within the golf cart and may transmit the playing scene to the studio. Then, the control unit 130 may replay the transmitted playing scene by representing it as an avatar on a studio display.

The control unit 130 may replay the playing scene of a player in the studio through a display mounted within the cart or through an external output device (AR glasses) worn by the player 501a.

The AR glasses worn by the player 501a outdoors may serve as both a caddy and a teaching professional, in addition to transmitting the playing scene in the studio.

The control unit 130 may also support bidirectional (studio and golf course) sound through the golf cart and thus may provide a live round experience.

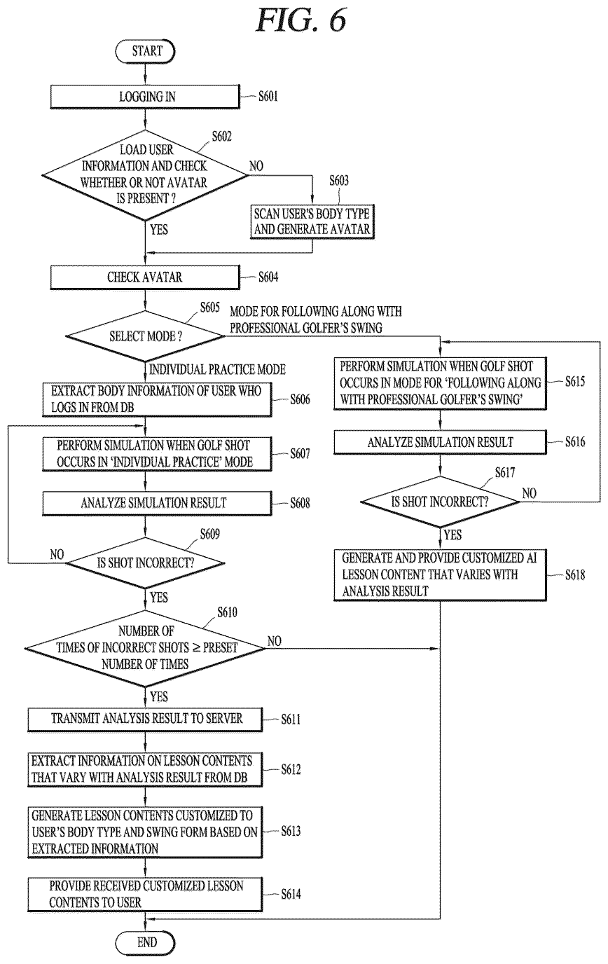

FIG. 6 is a flowchart referenced to describe a method, according to an embodiment of the present disclosure, of controlling the apparatus for providing a metaverse sports platform.

When a first mode is entered, the control unit 130 may analyze the user's swing whose is captured, through the above-mentioned image. Then, when the occurrence of a preset swing reaches or exceeds a reference number of times in the analyzed user's swing, the control unit 130 may transmit analysis information on the user's swing to the server through the communication unit.

In addition, the control unit 130 may receive information on swing correction from the server and may output the information on swing correction through the avatar's movement.

When a second mode is entered, the control unit 130 may output to the display an avatar that moves in a manner corresponding to the swing of a professional golfer whose image is captured in advance and may control the display in such a manner as to output both the avatar's swing corresponding to the user and a new avatar's swing.

Specifically, with reference to FIG. 6, when the user logs in (S601), the control unit 130 may first load user information and may determine whether an avatar is present (S602).

In a case where the avatar is not present, the control unit 130 may scan the user's body type through the camera 300 and may generate an avatar (S603).

When the avatar is present or generated, the control unit 130 may check (output) the avatar (S604) and may allow the user to select a mode (S605).

For example, when an individual practice mode (the first mode) is selected, the control unit 130 may extract body information of the user who logs in from a database or through an image captured through the camera (S606).

Subsequently, the control unit 130 may simulate the user's swing in the individual practice mode (S607) and may analyze a simulation result (S608). That is, when the first mode is entered, the control unit 130 may analyze the user's swing whose image is captured, through the above-mentioned image.

In a case where a shot is not incorrect, the control unit 130 may continue the simulation. In a case where a shot is incorrect, the control unit 130 may determine whether the number of incorrect shots reaches or exceeds a preset number of times (S609/S610).

At this point, a reference for the incorrect shot may be defined as a case where measured ball/club data (including a ball speed, a launch angle, left and right starting angles, a total amount of rotation, a rotational axis, a club speed, an impact point, an attack angle, a club pass, a face angle, an impact loft, an amount of head rotation, a lie angle, and similar data) falls outside a range of ball/club analysis data associated in advance with each club type.

When the occurrence of incorrect shots reaches or exceeds a preset number of times (a reference number of times), the control unit 130 may transmit the analysis information on the user's swing to the server through the communication unit (S611).

The control unit 130 may extract information on lesson contents that vary with the analysis result from the database station or may receive this information from the server (S612).

The control unit 130 may generate avatar lesson content customized to the user's body type and swing form based on the extracted information (S613) and may provide customized lesson content to the user (S614).

That is, the control unit 130 may receive the information on the swing correction from the server and may output the received information on the swing correction through the avatar's movement.

When a mode for following along with a professional golfer's swing (the second mode) is entered, the control unit 130 may perform the simulation (S615) and may analyze the simulation result (S616).

Subsequently, when an incorrect shot occurs in the simulation (S617), the control unit 130 may generate the customized lesson content that varies with the analysis result and may output this customized lesson content to the display (S618).

For example, when the second mode is entered, the control unit 130 may output to the display a new avatar that moves in such a manner as to correspond to the professional golfer's swing whose image is captured in advance, and may control the display in such a manner that both the swing of the avatar that corresponds to the user and the new avatar's swing are output.

In this manner, the customized lesson content provided in the first mode and the customized lesson content provided in the second mode may be different from each other.

According to the present disclosure, posture correction of the user's movement may be provided more intuitively through a user-based avatar based on the metaverse.

In addition, according to the present disclosure, the user-based avatar may be dressed in sports-associated clothing, and various content items may be provided by utilizing this user-based avatar. Consequently, a metaverse sports platform that enables a realistic reflection, as if the user were present in person in the metaverse, may be provided.

In addition, according to the present disclosure, a new sports platform capable of providing more diverse content items may be established by performing relay between the studio and the actual field through the metaverse.

Therefore, the detailed description should not be limitedly construed in all of the aspects, and should be understood to be illustrative. The scope of the present disclosure should be determined by reasonable interpretation of the appended claims, and all changes within the equivalent scope of the present disclosure are embraced by the appended claims.

1. An apparatus for providing a metaverse sports platform, the apparatus comprising:
a communication unit that receives a captured image from a camera;
a display that outputs the image captured through the camera; and
a control unit that, using the image captured through the camera, controls the display in such a manner as to output an avatar corresponding to a user included in the image and controls the avatar's movement in such a manner as to correspond to the user's swing,
wherein the control unit analyzes the user's swing and, using the avatar, outputs information necessary for correction.

2. The apparatus of claim 1, further comprising:
a sensor that is attached to the user's body and analyzes the user's movement,
wherein the control unit controls the avatar's movement in real-time in such a manner as to correspond to the user's swing, based on the image captured through the camera and information collected through the sensor.

3. The apparatus of claim 1, wherein, when the information necessary for correction is output, the control unit controls the display in such a manner that the avatar does not move in accordance with the user's movement.

4. The apparatus of claim 1, wherein the control unit sets the avatar's clothing in such a manner as to correspond to the clothing worn by the user, using the image captured through the camera.

5. The apparatus of claim 1, wherein, when a first mode is entered, the control unit analyzes the user's swing whose image is captured, through the image, and, when the occurrence of a preset swing reaches or exceeds a reference number of times, transmits analysis information on the user's swing to a server through the communication unit, and
wherein the control unit receives information on swing correction from the server and outputs the information on swing correction through the avatar's movement.

6. The apparatus of claim 1, wherein, when a second mode is entered, the control unit outputs to the display a new avatar that moves in such a manner as to correspond to a professional golfer's swing whose image is captured in advance, and controls the display in such a manner as to output both the swing of the avatar that corresponds to the user and the new avatar's swing.

7. The apparatus of claim 1, further comprising:
a sensor that is formed in such a manner as to be attached to a golf club and senses movement information of the golf club.

8. The apparatus of claim 7, wherein the control unit generates a swing plane object that is a plane on which the golf club moves, using the information sensed through the sensor, and controls the display in such a manner as to output the swing plane object.

9. The apparatus of claim 8, wherein the control unit controls the display so that both a corrective swing plane object, which guides a correct swing plane, and the swing plane object are output in an overlapping manner.

10. The apparatus of claim 1, wherein the control unit outputs prestored clothing information to the display in such a manner that the avatar is dressed in a clothing item selected by the user from the prestored clothing information.

11. The apparatus of claim 10, wherein the control unit controls the avatar dressed in the selected clothing item in such a manner to move in a way that corresponds to the user's movement.

12. The apparatus of claim 11, wherein, in a screen golf mode, the control unit controls the avatar dressed in the selected clothing information in such a manner as to perform a motion corresponding to the user's swing.

13. The apparatus of claim 1, wherein the control unit outputs a digitally twinned virtual space to the display in such a manner as to correspond to an actual golf course and controls the display in such a manner that a situation on the actual golf course whose image is captured through an image capture device is reflected in the digitally twinned virtual space.

14. The apparatus of claim 13, wherein the control unit outputs onto the virtual space a first avatar corresponding to the user whose image is captured through the camera, and a second avatar corresponding to a player who plays on the actual golf course.

15. The apparatus of claim 13, wherein the control unit controls the movement of the second avatar corresponding to a player in such a manner that the movement thereof corresponds to the swing of the player whose image is captured through the image capture device within the virtual space.

16. The apparatus of claim 15, wherein, in a case where the swing of the user, who is present in front of the camera, is in progress, the control unit controls the display in such a manner that a point in time in the virtual space is changed or that the second avatar corresponding to the player does not move.
